(19) United States
(12) Patent Application Publication
(10) Pub. No.: US 2009/0051661 A1
(43) Pub. Date: Feb. 26, 2009

(54) Method, Apparatus and Computer Program Product for Providing Automatic Positioning of Text on Touch Display Devices

(75) Inventors: Christian Kraft, Frederiksberg C (DK); Peter Dam Nielsen, Kgs. Lyngby (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/843,248

(22) Filed: Aug. 22, 2007

(51) Int. Cl. G06F 3/041

(52) U.S. Cl. 345/173

(57) ABSTRACT

An apparatus for providing automatic positioning of text on touch display devices may include a processing element. The processing element may be configured to receive an indication of a detection of touch event associated with an object, determine text corresponding to a location of the touch event, and provide for a display of the text at a different location within the object.

### TECHNOLOGICAL FIELD

Embodiments of the present invention relate generally to user interface technology and, more particularly, relate to a method, apparatus, and computer program product for providing automatic positioning of text on touch display devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. A user's experience during certain applications such as, for example, web browsing may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays.

Touch screen devices are now relatively well known in the art, with numerous different technologies being employed for sensing a particular point at which an object may contact or even approach the touch screen display. In an exemplary situation, pressure detection may be sensed over a relatively small area and the detection of such pressure may be recognized as a selection of an object, link, item, hotspot, etc. associated with the location of the detection of the pressure. Other mechanisms are also available including, for example, capacitive sensing which may be able to detect an object approaching the touch screen display. Accordingly, although we will refer herein to a touch screen display, it should be recognized that it is not necessary in all cases for a physical touch of the screen to occur in order to register an input as a touch event.

A familiar mechanism which has been used in conjunction with touch screen displays is a stylus. However, a pen, pencil or other pointing device may often be substituted for a dedicated instrument to function as a stylus. Such devices may be advantageous since they provide a relatively precise mechanism by which to apply pressure that may be detected over a corresponding relatively small area and can therefore be recognized as indicative of a user's intent to select a corresponding object, link, item, hotspot, etc.

Some users may consider it cumbersome to routinely remove or acquire a stylus or other pointing device to utilize a touch screen user interface. Accordingly, touch screen user interfaces have been developed in which a finger can be used to provide input to the touch screen user interface. However, a finger is typically larger than a stylus and therefore may block portions of the screen thereby making it difficult to see what is being selected. Accordingly, particularly in situations where the touch screen user interface is utilized in connection with a device having a relatively small sized display such as a mobile terminal, the use of fingers with touch screen displays may present difficulties for a user since the user cannot see which key is being pressed, or at least a view of the text associated with the key may be obstructed. As such, the user may consider the blockage of the user's view of the key to be a problem that may reduce user enjoyment or even increase user dissatisfaction with a particular application or service.

Accordingly, it may be desirable to provide a mechanism for overcoming at least some of the disadvantages discussed above.

### BRIEF SUMMARY

A method, apparatus and computer program product are therefore provided for providing automatic positioning of text on touch display devices. In particular, a method, apparatus and computer program product are provided that determine whether a location of a touch event corresponds to text within an object. The text may then automatically be moved such that hovering over or selecting the object may not result in rendering the text to be obstructed.

In one exemplary embodiment, a method of providing automatic positioning of text on touch display devices is provided. The method may include receiving an indication of a detection of touch event associated with an object, determining text corresponding to a location of the touch event, and providing for a display of the text at a different location within the object.

In another exemplary embodiment, a computer program product for providing automatic positioning of text on touch display devices is provided. The computer program product includes at least one computer-readable storage medium having computer-readable program code portions stored therein. The computer-readable program code portions include first, second and third executable portions. The first executable portion is for receiving an indication of a detection of touch event associated with an object. The second executable portion is for determining text corresponding to a location of the touch event. The third executable portion is for providing for a display of the text at a different location within the object.

In another exemplary embodiment, an apparatus for providing automatic positioning of text on touch display devices is provided. The apparatus may include a processing element. The processing element may be configured to receive an indication of a detection of touch event associated with an object, determine text corresponding to a location of the touch event, and provide for a display of the text at a different location within the object.

In another exemplary embodiment, an apparatus for providing automatic positioning of text on touch display devices is provided. The apparatus includes means for receiving an indication of a detection of touch event associated with an object, means for determining text corresponding to a location of the touch event, and means for providing for a display of the text at a different location within the object.

Embodiments of the invention may provide a method, apparatus and computer program product for improving display interface. More specifically, according to one embodiment, touch screen interface performance for use with a finger or other selection object may be improved. As a result, for example, mobile terminal users may enjoy improved capabilities with respect to web browsing and other services or applications that may be used in connection with a display such as a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing automatic positioning of text on touch display devices according to an exemplary embodiment of the present invention;

FIG. 3 illustrates an exemplary display prior to modification of an object according to an exemplary embodiment of the present invention;

FIG. 4 illustrates an exemplary display in which shifted text is provided corresponding to obstructed text according to an exemplary embodiment of the present invention;

FIG. 5 illustrates another exemplary display in which shifted text is provided corresponding to obstructed text according to an exemplary embodiment of the present invention; and

FIG. 6 is a block diagram according to an exemplary method for providing automatic positioning of text on touch display devices according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

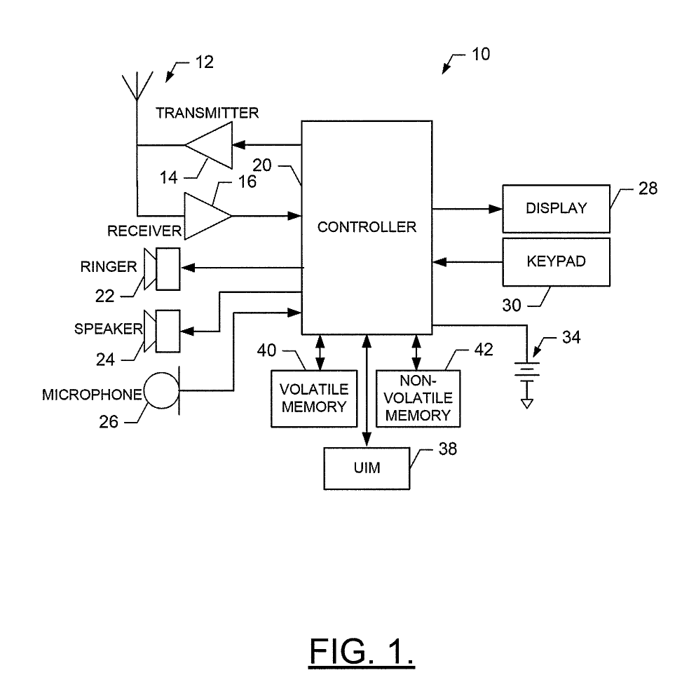

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

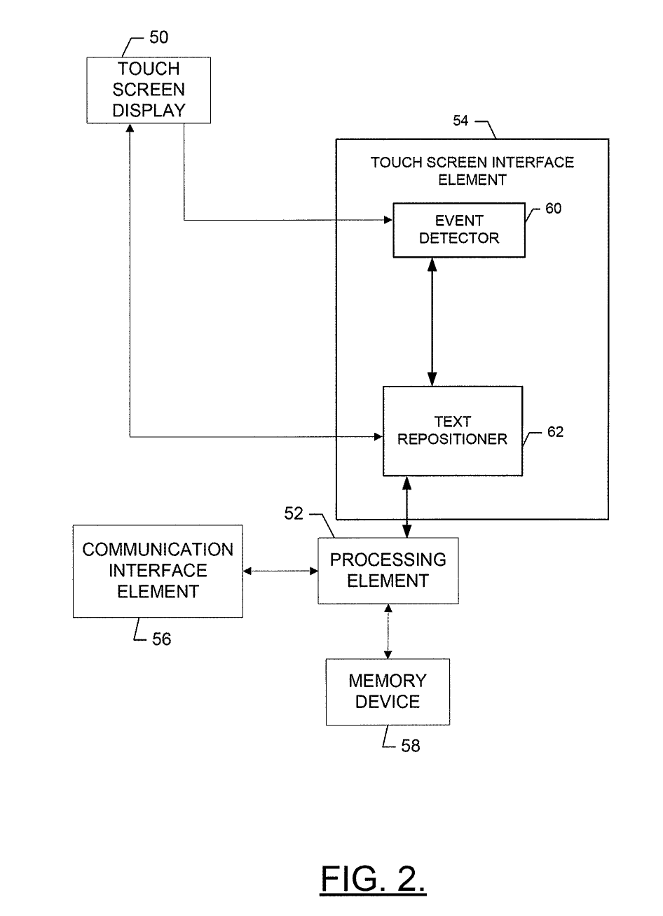

An exemplary embodiment of the invention will now be described with reference to FIG. 2, in which certain elements of an apparatus for providing automatic text positioning on touch display devices are displayed. The apparatus of FIG. 2 may be employed, for example, in conjunction with the mobile terminal 10 of FIG. 1. However, it should be noted that the apparatus of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of an apparatus for providing automatic positioning of text for touch screen devices, numerous other configurations may also be used to implement embodiments of the present invention.

Moreover, although an exemplary embodiment of the present invention described below will generally refer to key selection in the context of the selection of a number or letter on a touch screen keypad, embodiments of the present invention more generally relate to any selectable object including a text portion. In this regard, the object may include without limitation any of plain text links, clickable page elements, buttons, hotspots, list or grid items, etc., that include a text portion; all of which are generally referred to herein as objects. In this regard, the object may be defined as a region, the selection of which causes a corresponding function to be executed. Thus, for a link, for example, the object is the region that can be selected in order to connect to the address identified by the text characters of the text portion. Meanwhile, the text characters could be numbers, letters, symbols, graphics, etc., in any language, style, font, etc. Furthermore, although an embodiment of the present invention is described below in reference to a touch event associated with a touch screen display, it should be noted that the touch event need not correspond to an actual physical contact with the touch screen display since a touch event may correspond to a detection of an object brought into proximity with the touch screen display.

Referring now to FIG. 2, an apparatus for providing automatic positioning of text for touch screen display devices is provided. The apparatus may include or otherwise be in communication with a touch screen display 50 (e.g., the display 28), a processing element 52 (e.g., the controller 20), a touch screen interface element 54, a communication interface element 56 and a memory device 58. The memory device 58 may include, for example, volatile and/or non-volatile memory (e.g., volatile memory 40 and/or non-volatile memory 42). The memory device 58 may be configured to store information, data, applications, instructions or the like for enabling the apparatus to carry out various functions in accordance with exemplary embodiments of the present invention. For example, the memory device 58 could be configured to buffer input data for processing by the processing element 52. Additionally or alternatively, the memory device 58 could be configured to store instructions for execution by the processing element 52.

The processing element 52 may be embodied in a number of different ways. For example, the processing element 52 may be embodied as a processor, a coprocessor, a controller or various other processing means or devices including integrated circuits such as, for example, an ASIC (application specific integrated circuit). In an exemplary embodiment, the processing element 52 may be configured to execute instructions stored in the memory device 58 or otherwise accessible to the processing element 52. Meanwhile, the communication interface element 56 may be embodied as any device or means embodied in either hardware, software, or a combination of hardware and software that is configured to receive and/or transmit data from/to a network and/or any other device or module in communication with the apparatus. In this regard, the communication interface element 56 may include, for example, an antenna and supporting hardware and/or software for enabling communications with a wireless communication network.

The touch screen display 50 may be embodied as any known touch screen display. Thus, for example, the touch screen display 50 could be configured to enable touch recognition by any suitable technique, such as resistive, capacitive, infrared, strain gauge, surface wave, optical imaging, dispersive signal technology, acoustic pulse recognition, etc. techniques. The touch screen interface element 54 may be in communication with the touch screen display 50 to receive an indication of a touch event at the touch screen display 50 and to modify a response to the indication in certain situations. In particular, the touch screen interface element 54 may be configured to modify display properties of the touch screen display 50 with respect to an object associated with a touch event based on a determination as to whether the location of the touch event corresponds to a location of one or more text characters associated with the object. In other words, the touch screen interface element 54 may be configured to determine whether the touch event corresponds to a selection of the object and, more particularly, whether the touch event is likely to be obscuring text characters associated with the object. As stated above, the text characters could be numbers, letters, symbols, graphics, etc., in any language, style, font, etc.

The touch screen interface element 54 may be any device or means embodied in either hardware, software, or a combination of hardware and software configured to perform the respective functions associated with the touch screen interface element 54 as described herein. In an exemplary embodiment, the touch screen interface element 54 may be embodied in software as instructions that are stored in the memory device 58 and executed by the processing element 52. Alternatively, touch screen interface element 54 may be embodied as the processing element 52 including, for example, being embodied as instructions that are stored in the memory device 58 and executed by the processing element 52.

The touch screen interface element 54 may be configured to receive an indication of an input in the form of a touch event at the touch screen display 50. As suggested above, the touch event may be defined as an actual physical contact between a selection object (e.g., a finger, stylus, pen, pencil, or other pointing device) and the touch screen display 50. Alternatively, a touch event may be defined as bringing the selection object in proximity to the touch screen display 50 (e.g., hovering over an object or approaching an object within a predefined distance). In response to detection of a touch event at the touch screen display 50, the touch screen interface element 54 may modify a response to the touch event. In this regard, the touch screen interface element 54 may include an event detector 60, and text repositioner 62. Each of the event detector 60 and the text repositioner 62 may be any device or means embodied in either hardware, software, or a combination of hardware and software configured to perform the corresponding functions associated with the event detector 60 and the text repositioner 62, respectively, as described below. In an exemplary embodiment, each of the event detector 60 and the text repositioner 62 may be controlled by or otherwise embodied as the processing element 52.

The event detector 60 may be in communication with the touch screen display 50 to determine the occurrence of a touch event and a corresponding location of the touch event. In this regard, for example, the event detector 60 may be configured to receive an indication of a detection of a touch event and, based on the location of the touch event, determine whether the location of the touch event corresponds to the position of a displayed object. In an exemplary embodiment, the event detector 60 may be configured to further determine whether the location of the touch event corresponds to the position of one or more text characters associated with the object such that the selection object (e.g., a finger) may be likely to obstruct the view of the one or more text characters. Any text character or characters likely to be obstructed by the selection object may be identified by the event detector 60 as obstructed text. The event detector 60 may communicate the identity of the obstructed text and, for example, the corresponding object (e.g., key, link, icon, etc.) with which the obstructed text is associated to the text repositioner 62.

A determination as to which objects are selected by a particular touch event and which text may be obstructed can be accomplished in many ways. In an exemplary embodiment, the event detector 60 may be configured to communicate with the processing element 52 and/or the touch screen display 50 to receive information regarding the location of objects currently being displayed (and the corresponding text portions of the objects). Thus, when information relating to the location of a touch event is received, the event detector 60 may be configured to compare the location of the touch event to the locations of the objects and their corresponding text portions to determine which, if any, text portions may be obstructed text.

The text repositioner 62 may be configured to modify one or more characteristics of the object associated with the obstructed text in order to display at least the obstructed text portion of the object in an alternative manner. The modification performed by the text repositioner 62 may include movement of the obstructed text portion within the object, for example, in a direction away from a location of the touch event by a predetermined distance. In an exemplary embodiment, the obstructed text portion of the object may be moved (thereby forming shifted text) to another portion of the object (e.g., to a portion of the object that is not likely to be obstructed). In this regard, for example, a predefined distance from the location of the touch event may be considered as an area likely to be obstructed by the selection object. According to one example implementation, a radius of a circular area (e.g., defining an obstruction circle) centered upon the location of the touch event may define an area in which, if any text characters associated with an object fall within the area, the corresponding text characters may be considered to be obstructed text. The radius may therefore define a distance from the touch event outside which the obstructed text is to be moved. Although a circle may be used, it should be noted that other shapes could also be employed in embodiments of the present invention such as elliptical, irregular, polygonal, etc.

In an exemplary embodiment, a radius of the obstruction circle may be variable. In this regard, for example, the radius of the obstruction circle may be set in dependence upon a size of the selection object (e.g., finger, stylus, pen, etc.). In this regard, for example, the touch screen display 50 may provide characteristics of a detection of a touch event such as information indicative of a size of the object touching the touch screen display 50 (e.g., pressure per unit area) as a portion of the information communicated for the indication of the detection. As such, characteristics corresponding to a size of the selection object touching the touch screen display 50 being above a particular threshold may be designated to correspond to a finger and thereby trigger the event detector 60 to identify the indication of the detection of the touch event as a finger touch event. In other words, the event detector 60 may be configured to determine a size of the selection object based on the information received from the touch screen display 50.

Responsive to the size of the selection object as determined by the event detector 60, the event detector 60 may communicate a size associated with the selection object causing the touch event to the text repositioner 62. The text positioner 62 may then move the obstructed text, if any, outside of the obstruction circle or a predetermined distance from the location of the touch event based on the determined size of the selection object. As an alternative, rather than altering a size of the obstruction circle (or predetermined distance) based on a size of the selection object, the text repositioner 62 may be configured to alter a size of the obstruction circle (or predetermined distance) based on user settings. The user settings may be altered, for example, via a manual input using a toggle switch, a menu option, selecting a corresponding control in a toolbar, or via a dedicated or other, e.g., soft, key in a separate user interface such as a keyboard.

In an exemplary embodiment, the text repositioner 62 may be configured to move the obstructed text to a portion of the object that is outside the obstruction circle. In other words, the object may essentially remain unchanged except that the obstructed text is moved to another portion (e.g., nearer to an edge) of the object. In an alternative embodiment, the object itself may be modified. For example, the object may be enlarged in addition to movement of the obstructed text outside the obstruction circle. Alternatively, a shape of the object may be altered to facilitate movement of the obstructed text outside the obstruction circle. In this regard, for example, if a link containing text characters is selected as the object via a touch event, a shape of the link object may be altered to enable bending of the obstructed text around the obstruction circle. In an exemplary embodiment, changes in size and/or shape of the object may be made in response to a determination that the predetermined distance or the obstruction circle extends beyond the edges of the object. Accordingly, a size or shape of the object may be adjusted to enable repositioning of the obstructed text outside the obstruction circle or predetermined distance, but still within the object.

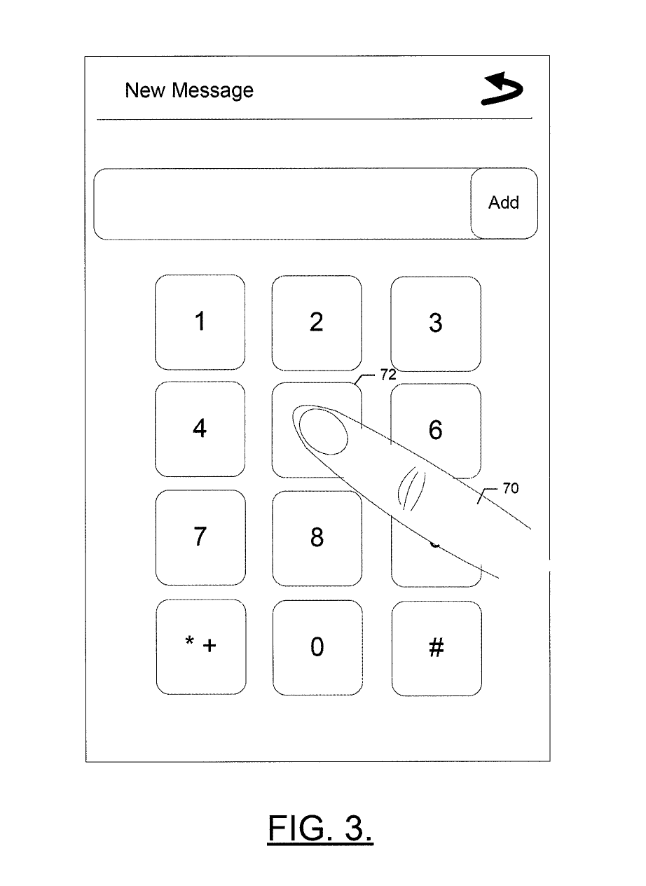

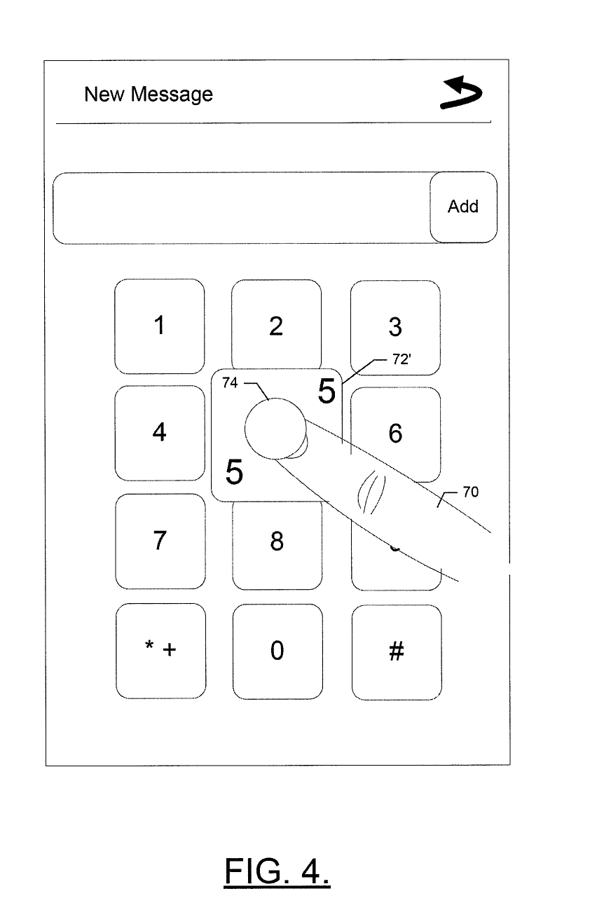

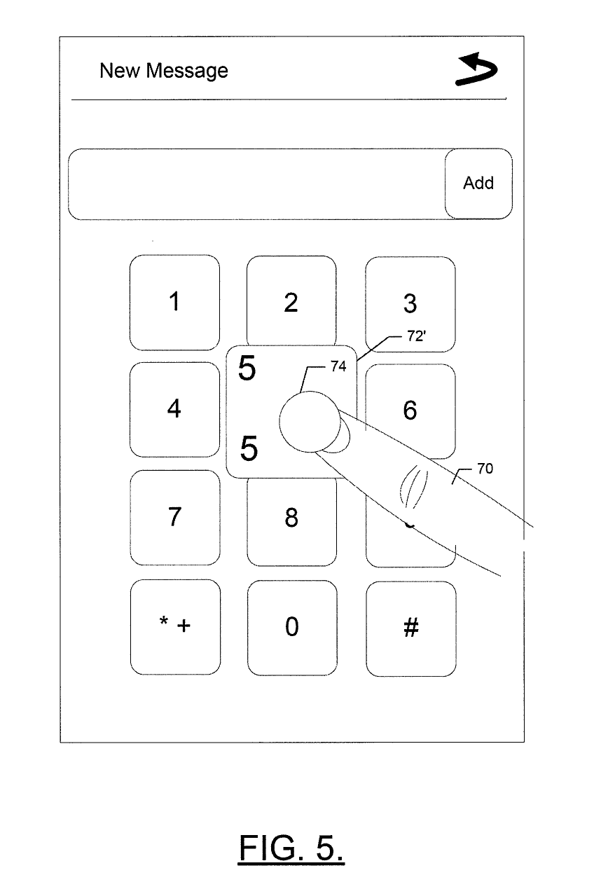

FIGS. 3-5 illustrate various renderings of a keypad on a touch screen display according to exemplary embodiments of the present invention. In this regard, FIG. 3 illustrates the obstruction of text (e.g., the number “5”) that may occur as a selection object (e.g., finger 70) approaches a key 72 (e.g., the “5” key on the keypad). The key 72 is an example of an object as described above. As may be appreciated from FIG. 3, the text character “5” may be considered to be obstructed text as the finger 70 approaches the key 72. FIG. 4 illustrates the movement of the obstructed text in accordance with an embodiment of the present invention. As shown in FIG. 4, in response to the detection of a touch event associated with the finger 70 touching or approaching the touch screen display to within a predefined distance, the text repositioner 62 may define a portion of the key 72 as corresponding to an obstruction circle 74. Of note, although the obstruction circle 74 is displayed in FIGS. 4 and 5, there is no requirement to display the obstruction circle 74. In fact, in an exemplary embodiment, the obstruction circle 74 is not actually displayed. As such, the obstruction circle 74 is displayed in FIGS. 4 and 5 for exemplary purposes only.

After determining the obstruction circle 74 the text repositioner 62 may move the obstructed text (thereby creating shifted text 76) to a portion of the key 72 that is outside of the obstruction circle 74. As shown in FIG. 4, the text repositioner 62 may modify the key 72 to produce a modified key 72′ having a different size and/or shape than the key 72. Other properties of the modified key 72′ may also be modified with respect to the key 72 such as color, transparency, opacity, etc. However, the function of the modified key 72′ may remain the same as the function of the key 72.

In an exemplary embodiment, the shifted text 76 may include one or more recreations of the obstructed text in an effort to ensure that the shifted text 76 is visible despite the presence of the selection object. In this regard, as indicated in FIGS. 4 and 5, the location within the modified key 72′ at which the shifted text 76 is displayed may be determined in dependence upon the location of the obstruction circle 74. For example, as indicated in FIG. 4, if the obstruction circle 74 is relatively centered with respect to the modified key 72′, the shifted text 76 may be displayed to include two (or more) recreations of the obstructed text that are displayed on opposite sides of the obstruction circle 74. Meanwhile, as indicated in FIG. 5, if the obstruction circle 74 is relatively close to a particular edge of the modified key 72′, the shifted text 76 may be displayed at an edge opposite of the particular edge. Alternatively or additionally, an angle at which the finger 70 approaches the display may be determined, for example, by the touch screen interface element 54 or the event detector 60. The angle determined may be indicative of with which hand the finger 70 corresponds. Accordingly, once the angle of the finger 70 has been determined, the angle may be communicated to the text repositioner 62. The text repositioner 62 may then move the shifted text 76 to a portion of the key 72 (or modified key 72′) that is less likely to be obstructed based on the determined angle. For example, if the angle determined is indicative of a finger of the right hand of the user (e.g., as shown in FIG. 5), the shifted text 76 may be shifted to the left to avoid obstruction. Properties of the shifted text 76 may be altered with respect to the properties of the obstructed text. For example, color, size, font, style, or other like properties of the shifted text 76 may be altered.

In an exemplary embodiment, the modified key 72′ and/or the shifted text 76 may appear for the period of time that the touch event occurs (e.g., from the time contact begins with the touch screen display until the time contact ends or from the time the selection object is in proximity of the touch screen display to the time the selection object is not in proximity of the touch screen display). Alternatively, the modified key 72′ and/or the shifted text 76 may appear for a predetermined time period after the start or end of the touch event.

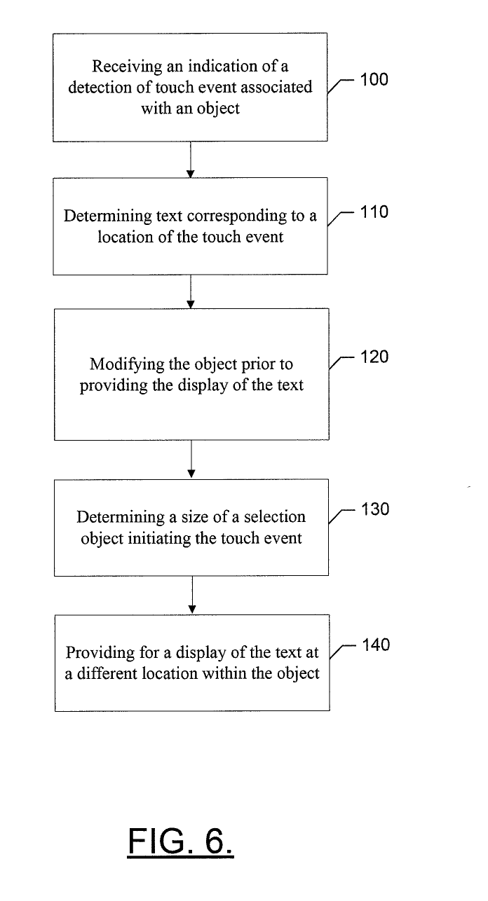

FIG. 6 is a flowchart of a method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In an exemplary embodiment, as illustrated in FIG. 6, a method for providing automatic positioning of text on a touch display device may include receiving an indication of a detection of touch event associated with an object at operation 100. In an exemplary embodiment, operation 100 may include receiving an indication of a physical touch of a touch screen display or receiving an indication of a selection object approaching the touch screen display to within a predetermined distance. At operation 110, text corresponding to a location of the touch event may be determined. A display of the text may then be provided at a different location within the object at operation 140. In this regard, providing for a display of the text at a different location may include directly displaying the text or providing signals to cause the display of the text at a different location. In an exemplary embodiment, the method may include modifying the object prior to providing the display of the text at operation 120.

In an exemplary embodiment, operation 140 may include generating more than one recreation of the text and providing the display of each of the more than one recreations of the text, which may be displayed at locations that are determined based on the location of the touch event relative to the object. Alternatively or additionally, operation 140 may include moving the text to a location within the object that is a predetermined distance from the touch event.

An optional operation 130 may include determining a size and/or angle of approach of a selection object initiating the touch event. Accordingly, providing the display of the text at a different location within the object may include moving the text to a location within the object that is a distance from the touch event that is determined based on the size of the selection object. Alternatively or additionally, displaying text at a different location within the object may include moving the text to a location within the object that is shifted and/or offset from the touch event based on the angle of approach of the selection object initiating the touch event.

In an exemplary embodiment, operation 110 may include determining an obstructed portion of the object based on the size of the selection object and operation 140 may include providing a display of the text at a location of the object that is outside of the obstructed portion of the object.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a detection of touch event associated with an object;
determining text corresponding to a location of the touch event; and
providing for a display of the text at a different location within the object.

2. A method according to claim 1, further comprising modifying the object prior to providing the display of the text.

3. A method according to claim 1, wherein providing for the display of the text at a different location within the object comprises generating more than one recreation of the text and providing the display of each of the more than one recreations.

4. A method according to claim 3, wherein providing for the display of the text at a different location within the object further comprises displaying the more than one recreation at portions of the object that are determined based on the location of the touch event relative to the object.

5. A method according to claim 1, wherein providing for the display of the text at a different location within the object comprises moving the text to a location within the object that is a predetermined distance from the touch event.

6. A method according to claim 1, further comprising determining a size of a selection object initiating the touch event.

7. A method according to claim 6, wherein providing for the display of the text at a different location within the object comprises moving the text to a location within the object that is a distance from the touch event that is determined based on the size of the selection object.

8. A method according to claim 1, wherein determining text corresponding to the location of the touch event comprises determining an obstructed portion of the object based on the size of the selection object and wherein providing for the display of the text at a different location within the object comprises providing a display of the text at a location of the object that is outside of the obstructed portion of the object.

9. A method according to claim 1, wherein receiving the indication comprises receiving an indication of a physical touch of a touch screen display or receiving an indication of a selection object approaching the touch screen display to within a predetermined distance.

10. A method according to claim 1, further comprising determining an angle of approach of the selection object with respect to the touch screen display and wherein providing for the display of the text at a different location within the object comprises moving the text to a location within the object that is determined based on the angle determined.

11. A computer program product comprising at least one computer-readable storage medium having computer-readable program code portions stored therein, the computer-readable program code portions comprising:
a first executable portion for receiving an indication of a detection of touch event associated with an object;
a second executable portion for determining text corresponding to a location of the touch event; and
a third executable portion for providing for a display of the text at a different location within the object.

12. A computer program product according to claim 11, further comprising a fourth executable portion for modifying the object prior to providing the display of the text.

13. A computer program product according to claim 11, wherein the third executable portion includes instructions for generating more than one recreation of the text and providing the display of each of the more than one recreations.

14. A computer program product according to claim 13, wherein the third executable portion includes instructions for displaying the more than one recreation at portions of the object that are determined based on the location of the touch event relative to the object.

15. A computer program product according to claim 11, wherein the third executable portion includes instructions for moving the text to a location within the object that is a predetermined distance from the touch event.

16. A computer program product according to claim 11, further comprising a fourth executable portion for determining a size of a selection object initiating the touch event.

17. A computer program product according to claim 16, wherein the third executable portion includes instructions for moving the text to a location within the object that is a distance from the touch event that is determined based on the size of the selection object.

18. A computer program product according to claim 11, wherein the second executable portion includes instructions for determining an obstructed portion of the object based on the size of the selection object and wherein the third executable portion includes instructions for providing a display of the text at a location of the object that is outside of the obstructed portion of the object.

19. A computer program product according to claim 11, wherein the first executable portion includes instructions for receiving an indication of a physical touch of a touch screen display or receiving an indication of a selection object approaching the touch screen display to within a predetermined distance.

20. A computer program product according to claim 11, further comprising a fourth executable portion for determining an angle of approach of the selection object with respect to the touch screen display and wherein the third executable portion includes instructions for moving the text to a location within the object that is determined based on the angle determined.

21. An apparatus comprising a processing element configured to:
receive an indication of a detection of touch event associated with an object;
determine text corresponding to a location of the touch event; and
provide for a display of the text at a different location within the object.

22. An apparatus according to claim 21, wherein the processing element is further configured to modify the object prior to providing the display of the text.

23. An apparatus according to claim 21, wherein the processing element is configured to generate more than one recreation of the text and providing the display of each of the more than one recreations.

24. An apparatus according to claim 23, wherein the processing element is configured to display the more than one recreation at portions of the object that are determined based on the location of the touch event relative to the object.

25. An apparatus according to claim 21, wherein the processing element is configured to move the text to a location within the object that is a predetermined distance from the touch event.

26. An apparatus according to claim 21, wherein the processing element is further configured to determine a size of a selection object initiating the touch event.

27. An apparatus according to claim 26, wherein the processing element is configured to move the text to a location within the object that is a distance from the touch event that is determined based on the size of the selection object.

28. An apparatus according to claim 21, wherein the processing element is configured to determine an obstructed portion of the object based on the size of the selection object and to provide for a display of the text at a location of the object that is outside of the obstructed portion of the object.

29. An apparatus according to claim 21, wherein the processing element is configured to receive an indication of a physical touch of a touch screen display or receive an indication of a selection object approaching the touch screen display to within a predetermined distance.

30. An apparatus according to claim 21, wherein the processing element is configured to determine an angle of approach of the selection object with respect to the touch screen display and to move the text to a location within the object that is determined based on the angle determined.

31. An apparatus comprising:
means for receiving an indication of a detection of touch event associated with an object;
means for determining text corresponding to a location of the touch event; and
means for providing for a display of the text at a different location within the object.

32. An apparatus according to claim 31, further comprising means for modifying the object prior to providing the display of the text.
